(19) United States
(12) Patent Application Publication
(10) Pub. No.: US 2005/0213528 A1
(43) Pub. Date: Sep. 29, 2005

(54) Audio distributon

(76) Inventors: Ronaldus Maria Aarts, Eindhoven (NL); Daniel Willem Elisabeth Schobben, Eindhoven (NL); Balthasar Antonius Gerardus Van Luijt, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/510,262

(22) PCT Filed: Mar. 20, 2003
(86) PCT No.: PCT/IB03/01102

§ 371 Date: Oct. 5, 2004

(30) Foreign Application Priority Data
Apr. 10, 2002 (EP) 02076412.2

(51) Int. Cl. H04J 3/08

(52) U.S. Cl. 370/315

(57) ABSTRACT

The present invention relates to a method for a service provider to distribute an audio signal to a listener. Before delivering the audio signal to the listener, the audio impression of the audio signal is personalized to the listener. The personalizing could e.g. be performed by filtering the audio signal using a set of head related transfer functions (HRTFs) defined by parameters being specific for the listener. This is for minimizing the interest of performing illegal copying of the audio signal. The invention further relates to a method of playing back a distributed audio signal and a playback device for playing back a distributed audio signal, where the personalization is detected and used as a watermark, which is identified and interpreted before playing back the distributed audio.

### FIELD OF THE INVENTION

The invention relates to a method of distributing music from a service provider to a listener. The invention also relates to an apparatus for distributing music from a service provider to a listener. The invention also relates to a method of playing back a distributed audio signal, and finally an apparatus for playing back a distributed audio signal.

### BACKGROUND OF THE INVENTION

Recently, the distribution of digital music over the Internet has gained in popularity and visibility. This is due, in part, to the widespread use of the MP3 music compression format, which permits relatively high quality reproduction of music using music files that are small enough to be downloaded by many home users. A typical three-minute song may be compressed into a file having a size of approximately 2.5 to 3 megabytes using MP3, while retaining sound quality comparable to the quality of music played from a compact disc. A home user connected to the Internet using a low cost modem capable of transferring 56 kilobits per second can download the song in a couple of minutes.

Numerous applications for playing digital music have been developed for use on personal computers. Additionally, portable digital music playback devices have been developed, which can download MP3 encoded music from a personal computer, and play the downloaded music. These portable music players have numerous advantages over previously known portable music players, such as portable cassette players or portable CD players. For example, since portable digital music players would typically store music in solid state memory, there are no mechanical parts that may cause skipping or other audible glitches in the music when the device is used during jarring physical activities. Additionally, portable digital music players can be made very small, and are not confined to a particular form factor by the media that they play.

These advantages have made portable digital music players very popular, with several companies manufacturing a variety of models that play MP3 encoded music.

MP3 players are also being built for use in automobiles, and as part of a home audio system. These digital music players often use a hard drive or a CDROM to store music. The primary advantage of such devices is their ability to store a large amount of music in a small space. For example, at approximately 1 megabyte per minute of CD-quality music stored in MP3 format, a single CD-ROM can store more than 10 hours of high quality music. Hard drives conforming to the size of a 3.5″ drive bay on a personal computer, and having capacities exceeding 20 gigabytes, are now available inexpensively. Such a drive could store more than 300 hours of high quality MP3 encoded music.

The ability to distribute digital music over a network, such as the Internet, offers several potential advantages to consumers and artists.

Consumers can choose specific songs that they wish to purchase, pay for those songs, and download them over the Internet. There is no need to travel to a music store, and the music can be delivered through a modem or other communication device within a few minutes. Since there is no manufacturing or packaging cost and only minimal distribution cost involved in providing digital music, the prices charged for digital music distributed over the Internet could be lower than what is charged for music distributed by other means, while still maintaining a relatively high profit margin. Once downloaded, digital music, such as MP3 formatted music, provides the consumer with a high degree of flexibility. The music may be stored in a searchable database, and played on any of a number of devices.

MP3 files provide no technological means of preventing perfect copies from being distributed illegally over the Internet. There is nothing in the MP3 format that prevents unauthorized copies from being played, that identifies the copyright holders or the licensee or that in any way ensures that the copyright holders will be compensated for use of the music.

As a result of this lack of copyright management, the recording industry has actively opposed the wide scale adoption of MP3 as a format for distributing music over the Internet. Instead, the industry has partnered with technology companies to form the Secure Digital Music Initiative (SDMI), to develop a digital music format with acceptable copyright management. So far, there has been considerable disagreement among SDMI members, and although a proposed standard has been announced, there are not yet any digital music players that implement the SDMI format. Due to the installed base of MP3 users and the growing popularity of MP3, it is unclear whether the recording industry's efforts to impose its own music formats will be successful.

The recording industry is also concerned about issues of retaining control over music content, and over marketing issues.

The participation of the recording industry in the distribution of digital music may be vital to the future of both the recording industry and the nascent digital music industry. Since the major record labels hold the rights to almost all popular music, and have contracts with almost all popular artists, and since it is important for them to hold on to these rights, it is unlikely that much popular music by major artists will be distributed in compressed digital format unless the concerns of the recording industry are addressed. At the same time, consumers may be unwilling to pay for digital music players that place severe restrictions on the availability of digital music, and for digital music that offers no price, quality, or selection advantages over what is available on other media, such as compact disks.

The invention also relates to other types of digital signals comprising audio, e.g. the wma-format or other signals comprising audio such as video (e.g. mpeg-format, avi-format) and computer games.

### OBJECT AND SUMMARY OF THE INVENTION

It is an object of the invention to provide advantageous audio distribution whereby the risk of unauthorized copying of distributed signals comprising audio data, such as music and video, is reduced.

This is obtained according to the present invention by a method for a service provider to distribute an audio signal to a listener, where, before the listener gets access to the audio signal, the audio impression of the audio signal is personalized to said listener, said personalizing being performed by filtering said audio signal using a set of head related transfer functions comprising listener parameters being specific for said listener.

Thereby, even if the audio data could be copied technically, the resulting sound experience is never optimal for anyone but the original listener. Further, after downloading the audio data, the audio has been provided with listener specific information being a kind of watermark, whereby it is possible to identify the listener by comparing identified parameters in audio data with parameters being stored in a database. A further advantage is that the service provider does not need to expose the original audio data to other parties, such as especially copyists. A further use of the invention is that HRTF filtered audio can be sold at a low price and then later the listener might want to buy the original audio.

In an embodiment, the personalization is performed before distributing said audio signal to said listener. Thereby, the service provider is assured that only personalized audio is distributed, minimizing the risk of unauthorized persons getting access to the original audio signal.

In a specific embodiment, the listener parameters in the set of head related transfer functions have been chosen between different sets of listener parameters being specific for said listener. Thereby, the listener can select an audio impression of specific interest. This could e.g. be a specific seat in the Carnegie Hall, at the front row of Wembley stadium, etc.

In another embodiment, the set of head related transfer functions has been modified in a substantially inaudible way, where said modification is performed by embedding information into the set of head related transfer functions before being used for filtering the audio signal. Thereby information can be added providing information that e.g. is to be interpreted by the playback device. The information could e.g. be an expiry date of the audio signal, after which the audio signal may no longer be played back.

The invention also relates to a method of playing back a distributed audio signal, wherein the audio impression of the audio signal has been changed according to first listener parameters being specific for a specific listener, comprising the steps of:
detecting said first listener parameters used for changing the audio impression of said audio signal,
comparing said detected first listener parameters with second listener parameters,
playing back said audio signal if said detected first listener parameters identify a listener being identical to the listener identified by said second listener parameters.

Thereby the playback device can use the modification as a watermark and determine whether the audio signal has been bought by the owner/user of the playback device. The modification can be specific listener parameters such as listening room acoustics, type of speaker, range of hearable frequencies, etc.

In a specific embodiment the steps of:
detecting said first listener parameters used for changing the audio impression of said audio signal and
comparing said detected first listener parameters with second listener parameters, are performed by comparing the audio signal that has been changed according to said first listener parameters with a corresponding audio signal having been changed according to said second listener parameters. This is a simple way of detecting and comparing the audio.

In an embodiment, the first and second listener parameters are parameters to be used in a set of head related transfer functions, and wherein the audio signal has been changed by filtering it using the set of head related transfer functions having listener parameters being specific for a specific listener. The HRTFs are very listener specific functions, which are unique for each listener, therefore a fingerprint is provided on the music, making it possible to clearly identify the right listener.

In a specific embodiment the steps of:
detecting said first listener parameters used for changing the audio impression of said audio signal and
comparing said detected first listener parameters with second listener parameters, are performed by comparing the frequency spectrum of the audio signal having been filtered by the set of head related transfer functions having said first listener parameters and the frequency spectrum of the set of head related transfer functions having said second listener parameters. This can be a very reliable way of detecting and comparing and it does not require access to the original audio signal.

In a specific embodiment the method further comprises the step of:
detecting information having been embedded into the head related transfer function before filtering the audio signal and, if the detected first listener parameters identify a listener being identical to the listener identified by said second listener parameters, playing back the audio signal according to the detected information.

Thereby, information that has previously been embedded by e.g. a service provider can be detected and an action can be taken according to the information. An action could be not playing back the audio because of the embedded information.

The invention further relates to an apparatus for playing back a distributed audio signal, wherein the audio impression of the audio signal has been changed according to first listener parameters being specific for a specific listener, comprising:
means for detecting said first listener parameters used for changing the audio impression of said audio signal,
means for comparing said detected first listener parameters with second listener parameters stored locally, and
means for playing back said audio signal if said detected first listener parameters identify a listener being identical to the listener identified by said second listener parameters.

WO 01/24576 discloses remote audio processing dependent on hearing profiles for persons with hearing problems and the use of psycho acoustical processing. In this document the processing is not for copy protecting audio, but only for optimizing the sound for listeners with hearing disabilities.

### BRIEF DESCRIPTION OF THE DRAWINGS

In the following preferred embodiments of the invention will be described referring to the figures, where

FIG. 1 illustrates the method according to the present invention,

FIG. 2 illustrates an apparatus according to the present invention,

FIG. 3 shows how the HRTF information in audio data can be used as a watermark for identifying the listener of the audio data and

FIG. 4 illustrates a method of playing back distributed audio data using a playback device.

### DESCRIPTION OF PREFERRED EMBODIMENTS

In the present invention a set of head related transfer functions (HRTFs) is used to personalize audio to a specific person. The HRTFs are defined as functions describing how sound propagates from a specific sound source to the ear, and the number of HRTFs belonging to a set could be from one HRTF describing sound propagation from a source to the ears to a number of HRTFs depending on the number of sources delivering sound and the number of ears.

In the following HRTF is defined. By finding the sound pressure produced by an arbitrary source at the eardrum (taking into consideration parameters such as the distance between the ears and the shape of the outer ear), all that is needed is the impulse response from the source to the eardrum, which e.g. can be measured by placing a microphone in the ear. This is called the Head-Related Impulse Response, and its Fourier transform is called the Head Related Transfer Function (HRTF). The HRTF captures all of the physical cues to source localization. Once you know the HRTF for the left ear and the right ear, you can synthesize accurate binaural signals from a monaural source. The head related transfer function is well known and is described in a number of documents, such as (Blauert, Spatial hearing: The Psychophysics of Human Sound Localization (MIT Press, Cambridge, Mass., 1983). When audio is filtered by a set of HRTFs, the audio is optimized for the person to whom the set of HRTFs belongs, and therefore the sound experience is never optimal for anyone but the person to whom the set of HRTFs belongs. The HRTFs are filter functions with parameters or coefficients being specific for specific persons. For a specific person different sets of HRTFs can be obtained depending on the arbitrary source mentioned above. The HRTFs depend among other things on the distance between the source and the person and also the characteristics of the room in which the function parameters are. When the source is e.g. a headphone, the HRTFs depend on the headphone through which sound reproduction takes place. The result of filtering audio using this function is that an optimal spatial reproduction of surround audio in headphones is obtained. The source could also be a typical loudspeaker; in this case it is necessary to perform cross-talk cancellation, which can be based e.g. on the HRTF.

FIG. 1 illustrates the method according to the present invention; a listener 101 delivers data 103 to be used for generating a set of head related transfer functions (HRTFs) to a service provider 105. The listener requests audio data 107 such as a piece of music or other multimedia data comprising audio such as a movie or a computer game. The service provider 105 then reads audio data 109 from a storage medium 111 and filters the data using the listener specific set of HRTFs. The filtered data 113 are then distributed to the listener 101 and the listener 103 can now play back the data and experience the optimized audio.

The listener could obtain the listener data in e.g. music stores, at home, warehouses or another measuring location, where equipment for measuring the HRTF parameters is available. Further, the measuring could be performed using a network connection between a measuring location and the listener. When measuring the HRTF parameters, the listener can choose, which environment the audio experience should simulate, this could e.g. be a specific seat in the Carnegie Hall, at the front row of Wembley stadium, etc. In this case, the listener will not necessarily have to be present at that particular environment; the measuring location might already have general data about acoustics at these places, which then can be incorporated in the listener measuring process. A number of different sets of HRTF parameters can thereby be generated for each listener, and when the listener requests the audio data, he also makes a selection of which environment the audio experience should simulate.

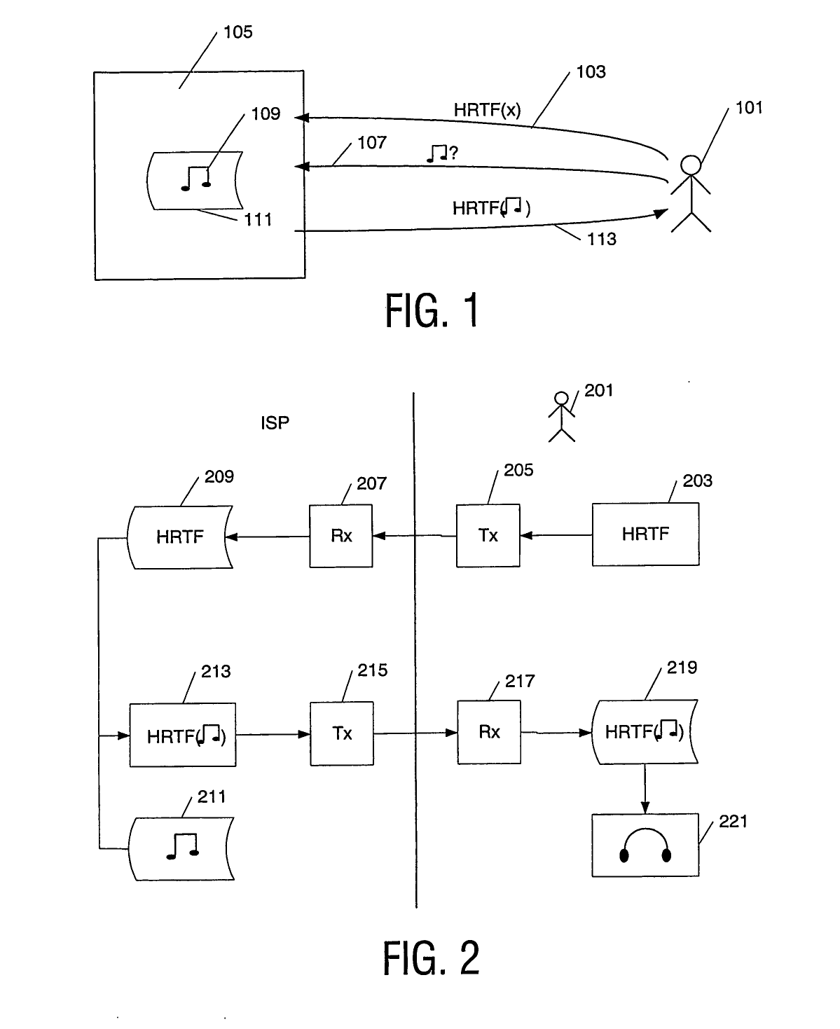

FIG. 2 illustrates an apparatus according to the present invention. In a specific embodiment the service provider is an Internet service provider (ISP). The ISP offers multimedia data comprising audio to listeners by using a public communication network, such as the Internet. In order for the listener to be able to buy music, it is necessary that the ISP has at least one set of listener specific parameters to be used in a set of HRTFs. Parameters for simulating the environment are then used in combination with the listener specific parameters when generating the set of HRTFs, and a number of environment specific HRTF parameters can then be obtained for each listener. The listener transmits the obtained HRTF parameters 203 to the ISP using a transmitter. In this specific case the transmitter is an I/O adapter in a computer communicating with the ISP over the Internet.

The ISP then receives the parameters using a receiver 207; the receiver could e.g. be an I/O adapter in a server communicating with the transmitter over the Internet. In an embodiment, the parameters are stored in a database 209. This database could comprise parameters from a number of listeners, which are identifiable e.g. by a listener ID. Further, the database could also comprise different sets of parameters for one listener, the parameters being specific for different environments as mentioned above. Then, when the listener requests audio data e.g. using a web page belonging to the ISP, the listener enters an ID and identifies the requested audio data. The ISP then locates the HRTF parameters of the listener according to the ID, whereafter the ISP locates the audio data in a database 211. The identified audio data are filtered 213 using the HRTF parameters of the listener. A transmitter 215 transmits the filtered audio data to the listener over the Internet, which is received at the listener by the receiver. Again the receiver could e.g. be an I/O adapter in a computer communicating with the transmitter over the Internet, and the transmitter an I/O adapter in a server communicating with the listener over the Internet. The receiver 217 stores the received data in a database 219. The audio data are now available to the listener for playback by a playback device 219 receiving data from the database 221. The playback device could be any device, such as a portable DVD, CD, MP3 player etc. Because of the above, the processed audio has characteristics that are unique for one listener. Therefore, even if the result could be copied technically, the resulting sound experience is never optimal for anyone but the original listener. Further, after downloading the audio data, the audio has been provided with listener specific information being a kind of watermark, whereby it is possible to identify the listener by comparing identified parameters in audio data with parameters being stored in e.g. the database 209. The set of HRTFs could also be modified in an inaudible way, making it possible to embed information into the set of HRTFs. The information could e.g. be a date until which the listener is allowed to playback the audio data.

By performing the filtering of the audio data using a set of HRTFs before the data is downloaded over the Internet to the listener, two or more sound channels are ‘mapped’ to exactly two signals representing the left and right speaker. Thereby there is only need for two channels when downloading.

The invention is not limited to distribution over the Internet. The service provider could also send a CD to the listener after the audio content of the CD has been personalized using HRTF. Further, the listener might be the service provider himself, and when he makes copies of an original CD, then the copies are filtered using listener specific HRTFs. Thereby the audio is optimized for the listener, and further the audio is personalized making it less interesting for other users. The HRTF functionality could be incorporated in a CD recorder device in such a way that it is only possible to record audio after the audio has been filtered by a listener specific HRTF.

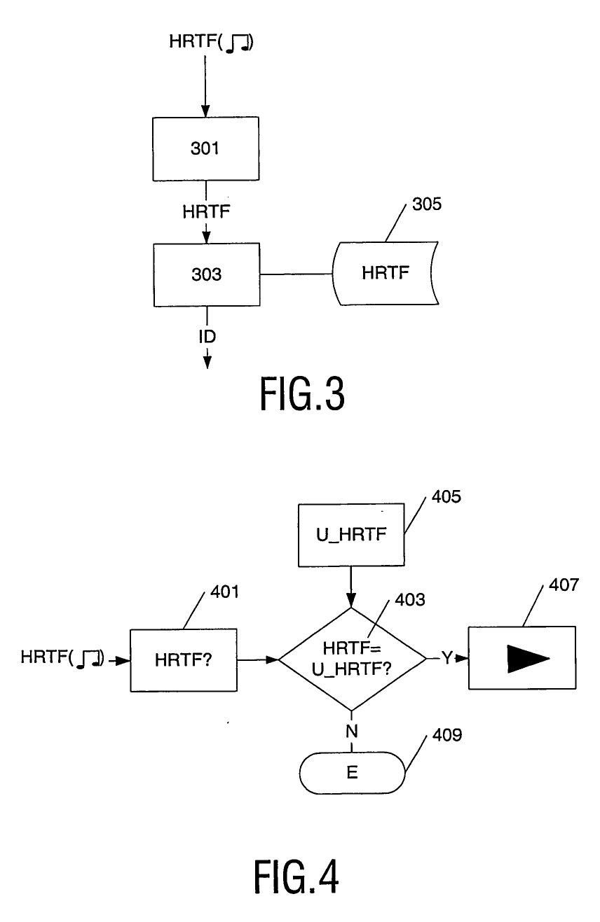

In FIG. 3 it is shown how the HRTF information in audio data can be used as a watermark for identifying the listener of the audio data. First of all, the original content is identified 301 using hashing, such as fingerprinting. The HRTF parameters can then be extracted from the audio data by comparing the audio data with the original audio data. Another method of identifying 301 the HRTF parameters could also be the searching for features in the frequency spectrum of the audio data and comparing these with notches in a different set of HRTFs. After the HRTF parameters have been extracted, the listener can be identified by comparing 303 the extracted listener specific HRTF parameters with data in a database 305 linking HRTF parameters with listener ID's. This database could in one embodiment be the database 209 at the ISP mentioned in FIG. 2. The whole identification process could be performed by a microprocessor executing a program designed for performing the above step.

In FIG. 4 a method of playing back distributed audio data by a playback device is illustrated. Before playing back the audio, the set of HRTFs that has been used for filtering the audio is extracted 401. This can be done as mentioned in the description of FIG. 3. The detected HRTF parameters are then compared 403 to a listener specific HRTF 405 (U_HRTF) stored on the device, and linking the listener to the device. If the extracted set of HRTFs equals the listener specific set of HRTFs, the audio has not been copied illegally, and the audio data can be played back 407 by the playback device. Otherwise, the audio data is deemed to be illegal, and the playback process is ended 409. The playback device could be any device connected to headphones or loudspeakers, such as a portable DVD, CD, MP3 player etc, where the device comprises processing means, such as a microprocessor for performing the HRTF detection.

In a specific embodiment, the playback device further comprises means for detection and interpretation of the additional information that has been embedded in the set of HRTFs. One application of this could for example be to detect the date until which the listener is allowed to play back the audio signal, and if the date has expired, then the playback device will not playback the audio signal.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, the present invention relates to a method for a service provider to distribute an audio signal to a listener. Before delivering the audio signal to the listener, the audio impression of the audio signal is personalized to the listener. The personalizing could e.g. be performed by filtering the audio signal using a set of head related transfer functions (HRTFs) defined by parameters being specific for the listener. This is for minimizing the interest of performing illegal copying of the audio signal. The invention further relates to a method of playing back a distributed audio signal and a playback device for playing back a distributed audio signal, where the personalization is detected and used as a watermark, which is identified and interpreted before playing back the distributed audio.

1. A method for a service provider to distribute an audio signal to a listener, where, before the listener gets access to the audio signal, the audio impression of the audio signal is personalized to said listener, said personalizing being performed by filtering said audio signal using a set of head related transfer functions comprising listener parameters being specific for said listener.

2. A method according to claim 1, wherein the personalization is performed before distributing said audio signal to said listener.

3. A method according to claim 1, wherein the listener parameters in the set of head related transfer functions have been chosen between a number of sets of listener parameters being specific for said listener.

4. A method according to claim 1, wherein the head related transfer functions have been modified in an substantially inaudible way, where said modification is performed by embedding information into the set of head related transfer functions before filtering the audio signal.

5. A method of playing back a distributed audio signal, wherein the audio impression of the audio signal has been changed according to first listener parameters being specific for a specific listener, comprising the steps of:
detecting said first listener parameters used for changing the audio impression of said audio signal,
comparing said detected first listener parameters with second listener parameters and
playing back said audio signal if said detected first listener parameters identify a listener being identical to the listener identified by said second listener parameters.

6. A method according to claim 5, wherein the steps of:
detecting said first listener parameters used for changing the audio impression of said audio signal and
comparing said detected first listener parameters with second listener parameters,
are performed by comparing the audio signal that has been changed according to said first listener parameters with a corresponding audio signal having been changed according to said second listener parameters.

7. A method according to claim 5, wherein first and second listener parameters are parameters to be used in a set of head related transfer functions, and wherein the audio signal has been changed by filtering it using the set of head related transfer functions having listener parameters being specific for a specific listener.

8. A method according to claim 7, wherein the steps of:
detecting said first listener parameters used for changing the audio impression of said audio signal and
comparing said detected first listener parameters with second listener parameters stored locally
are performed by comparing the frequency spectrum of the audio signal having been filtered by the set of head related transfer functions having said first listener parameters, and the frequency spectrum of a set of head related transfer functions having said second listener parameters.

9. A method according to claim 6, further comprising the step of:
detecting information having been embedded into the head related transfer function before filtering the audio signal and, if the detected first listener parameters identify a listener being identical to the listener identified by said second listener parameters, playing back the audio signal according to the detected information.

10. An apparatus for playing back a distributed audio signal, wherein the audio impression of the audio signal has been changed according to first listener parameters being specific for a specific listener, comprising:
means for detecting said first listener parameters used for changing the audio impression of said audio signal,
means for comparing said detected first listener parameters with second listener parameters and
means for playing back said audio signal if said detected first listener parameters identify a listener being identical to the listener identified by said second listener parameters.
